(19) United States
(12) Patent Application Publication
(10) Pub. No.: US 2024/0359511 A1
(43) Pub. Date: Oct. 31, 2024

(54) SCALE FOR A TOWABLE VEHICLE

(71) Applicants: Garo AFARIAN, Arndell Park (AU); Shojaeddin MIRFENDERESKI, Arndell Park (AU)

(72) Inventors: Garo AFARIAN, Arndell Park (AU); Shojaeddin MIRFENDERESKI, Arndell Park (AU)

(21) Appl. No.: 18/528,882

(22) Filed: Dec. 5, 2023

(30) Foreign Application Priority Data
Dec. 5, 2022 (AU) 2022903712

(51) Int. Cl. B60D 1/06; B60D 1/36; B60D 1/58

(52) U.S. Cl. CPC B60D 1/065; B60D 1/363; B60D 1/583

(57) ABSTRACT

A scale including a frame configured to mount a caravan or trailer at a very similar height and location as a trailer hitch, to provide the trailer with weighing geometry similar to real towing conditions. There is also described a scale which mounts on a prime mover hitch, having a weighing station adjacent the hitch, disposed at the same level as the hitch. Also, there is described a tow ball load scale including: a frame including: a mount for mounting the frame to a coupler, towball or hitch of a prime mover; a towball or coupler receiver spaced along the frame from the mount, the towball or coupler mount being configured to cooperate with a trailer coupler for measuring a vertical towball load, and further including one or more load cells disposed thereon. There is also described a method of measuring a trailer towball downforce, the method including the steps of: receiving downforce load cell signal data relating to towball load in a computer processor from a towball or coupler receiver; using the downforce load cell signal data in a fit function saved in the computer processor to output a calculated trailer downforce load data; comparing the calculated trailer downforce load data with threshold load data to produce a safety data signal; sending the safety data signal and/or calculated trailer downforce data to a mobile device, or selecting a lamp or alert actuation signal and sending to a selected lamp or loudspeaker mounted on the frame, based on the safety data signal.

### TECHNICAL FIELD

The present technology relates generally to towball scales for caravans, boat trailers, and other towed vehicles.

### BACKGROUND ART

Trailing caravans and boats can be dangerous. It is important to balance the downward forces of the towed vehicle. Most of the downward force must be over the caravan or trailer wheels, but some should be on the towball. There can be fatal consequences if these downward forces of the towed vehicle are not correctly balanced.

First, too much downforce on the towball is dangerous because it can reduce ground clearance at the back of the prime mover (towing vehicle), reduce steering response, and bend the chassis, among other issues.

Secondly, too little towball downforce introduces trailer instability in that it does not allow a trailer sway oscillation to damp. Thus, if a sway begins during towing, on a trailer with too little downward tow ball force applied, the trailer sway increases until the trailer drives sideways and flips, taking the prime mover with it, tail first. Too little tow ball mass can also reduce traction on rear-wheel-drive vehicles up large inclines.

In the US and Australia, the downward tow ball load is legislated to be about 10% of Gross Trailer Mass while in Europe it is about 6%. This difference can be accounted for by legislated maximum road speed for trailed vehicles. In Europe the maximum allowable speed is lower than in the US or Australia.

On caravans in particular, the mass inside can move around a lot, from trip to trip. Sometimes the water tanks and bladders on board a caravan are full, and other times they are empty. Other loads are moved around: suitcases, batteries and such. This has the ability to affect the tow ball load, and the same tow ball load on one trip can be different on another trip, even if the caravan/trailer drawbar is level. The same goes for boats, in that the fuel tanks can be full or empty, and the boat can be loaded further forward on the trailer one trip compared to another.

There are trailer scales, but most seem to use the jockey wheel mass, which is inaccurate and difficult to measure—the jockey wheel needs to be fiddled around with etc. It's a hassle.

The present inventors have sought to invent a new tow ball scale which substantially ameliorates one or more of the abovementioned disadvantages or at least provides a new alternative to known scales.

### SUMMARY OF INVENTION

Broadly, the present invention seeks to provide a tow ball load scale which is more accurate, and easier to use, than known tow ball scales.

Broadly, the present technology seeks to provide a tow ball load scale which is more accurate and easier to use than known tow ball scales, by providing a scale disposed at the same level as the hitch, between the prime mover hitch and the trailer coupler.

In accordance with one aspect of the present technology there is provided a scale comprising a frame configured to mount a caravan or trailer at a very similar height and location as a trailer hitch, to provide the trailer with weighing geometry similar to real towing conditions.

In accordance with another aspect of the present technology there is provided a scale which mounts on a prime mover hitch, having a weighing station adjacent the hitch, disposed at the same level as the hitch.

In one aspect of the present technology there is provided a tow ball load scale including:
a frame including:
   a mount for mounting the frame to a coupler, towball or hitch of a prime mover;
   a towball or coupler receiver spaced along the frame from the mount, the towball or coupler mount being configured to cooperate with a trailer coupler for measuring a vertical towball load, and further including one or more load cells disposed thereon.

In another aspect of the present technology there is provided a method of measuring a trailer towball downforce, the method including the steps of:
receiving downforce load cell signal data relating to towball load in a computer processor from a towball or coupler receiver;
using the downforce load cell signal data in a fit function saved in the computer processor to output a trailer downforce load data;
comparing the trailer downforce load data with a threshold load data range to produce a safety data signal.

In one embodiment the method further includes the step of sending the trailer downforce load data and/or safety data signal to a mobile device.

In one embodiment the method includes the step of initiating a calibration routine.

In one embodiment the calibration routine includes a processor transmitting or otherwise actuating or sending a warning data signal.

In one embodiment the warning data signal includes a buzzer actuation data signal.

In one embodiment the warning data signal includes a warning data signal transmitted to the mobile device.

In one embodiment the method further includes the step of initiating the load cell.

In one aspect of the present technology there is provided a tow ball load scale including:
a frame including:
   a mount at a proximal end for mounting the frame to a coupler, towball or hitch of a prime mover;
   a weighing station disposed on a second coupling region, adjacent the mount on the frame.

In one embodiment the weighing station is a towball, or coupler receiver, spaced along the frame from the mount towards a distal end, the towball or coupler mount being configured to cooperate with a trailer coupler for measuring a vertical towball load, and further including one or more load cells disposed thereon.

In another aspect of the present technology there is provided a method of measuring a trailer towball downforce, the method including the steps of:
receiving downforce load cell signal data relating to towball load in a computer processor from a towball or coupler receiver;
using the downforce load cell signal data in a fit function saved in the computer processor to output a trailer downforce load data;
comparing the trailer downforce load data in the computer processor with a threshold load data range to output a safety data signal;
selecting a lamp or alert actuation signal and sending to a selected lamp or alert mounted on the frame, based on the safety data signal.

In one embodiment the method includes the step of sending an alarm signal to a mobile device or loudspeaker if the safety data signal shows that the trailer downforce load data is higher or lowers than the threshold data range.

In one embodiment the method includes the step of amplifying, in the processor, the load cell signal data to form an amplified signal for ease of use in a fit function.

In one embodiment the method further includes the step of dividing, in the processor, the amplified signal by 1000 to form a baseline signal load data point.

In one embodiment the baseline signal load data point is used in a fit function stored in the processor which uses linear regression to produce a trailer down force load data point.

In one embodiment the fit function is stored in EPROM in a processor.

In one embodiment the processor onboard the frame compares with the threshold data to produce a safe signal output or a warning signal output, depending on whether the baseline signal load data point is within a predetermined threshold or without the predetermined threshold.

In one embodiment the safe signal output is a selected “safe zone” lamp activation signal sent to an onboard lamp, or to a mobile device.

In one embodiment, if the comparison step yields a result outside the predetermined threshold then the processor will output a warning lamp activation signal to an onboard warning lamp.

In one embodiment the processor may output a warning activation signal to a loudspeaker or vibrator module to indicate the warning to a user.

In one embodiment the mount includes a hitch receiving zone to receive a hitch.

In one embodiment the hitch receiving zone includes a towball retainer.

In one embodiment the hitch receiving zone includes a skirt for locating the frame on a hitch tongue.

In one embodiment the towball retainer includes a towball retaining bar at a proximal end of the frame, to hook under the shoulder of a towball, inhibiting release under load.

In one embodiment the hitch receiving zone is at a proximal end of the frame, and the weighing station is spaced from the hitch receiving zone, toward the distal end of the frame.

In one embodiment an adjuster is provided which adjusts the level of the weighing station relative to the mount.

In one embodiment the adjuster is a threaded screw or bolt mounted on the skirt, which can tilt the frame.

In one embodiment there is provided a lock to lock the frame onto the hitch tongue of the prime mover.

In one embodiment the weighing station is a mock towball. The mock towball includes a single 1-axis load cell, oriented to measure vertical load.

In one embodiment the mock towball includes a hollow towball with a bore for receiving a load cell actuator pin.

In one embodiment the load cell actuator pin is fastened in the bore with a fastener and/or adhesive resin.

In one embodiment the weighing station includes alert lights of different colours for different load conditions calculated by the processor.

In one embodiment the weighing station includes loudspeaker for making alert sounds.

In one embodiment the weighing station is powered by a 7-pin trailer plug.

In one embodiment the weighing station processor is powered by the lights pin or the auxiliary pin on the 7-pin plug.

In one embodiment the weighing station includes a 7-pin plug with at least one power pin to the auxiliary pin on the prime mover socket and/or the lights pin on the prime mover socket.

In a yet further aspect of the present invention there is provided a caravan and trailer towball downforce scale which includes a weighing station powered by a prime mover trailer socket.

### BRIEF DESCRIPTION OF DRAWINGS

To enable a clearer understanding, an embodiment of the present invention will be hereinafter described with reference to the drawings, and in those drawings:

FIG. 1 is a perspective view of an embodiment of the scale frame from the distal end and right side;

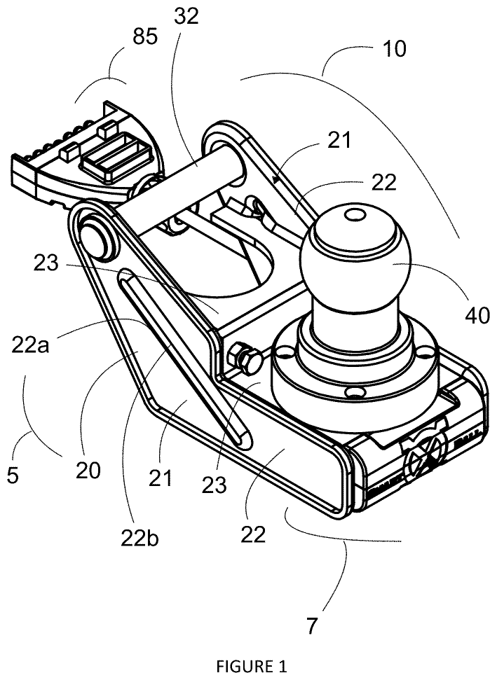

FIG. 2 is another perspective view of the embodiment from the distal end of the scale frame, and left side;

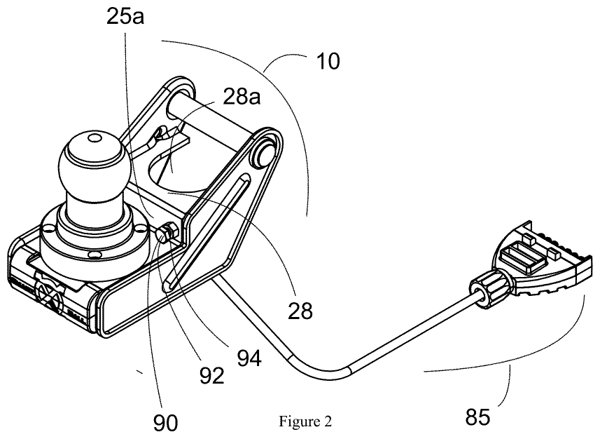

FIG. 3 is a left side view of the embodiment;

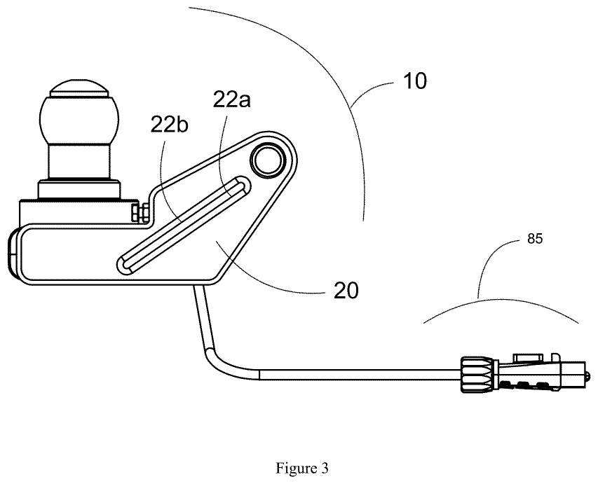

FIG. 4 is a front view, from the distal end;

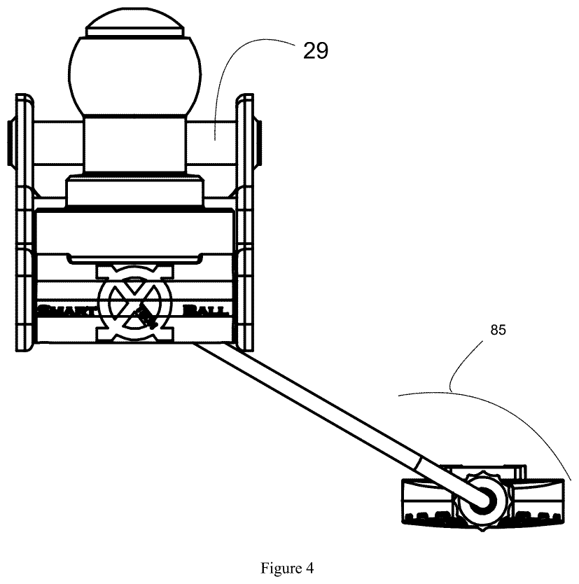

FIG. 5 is a base view, that is to say, a plan view from underneath;

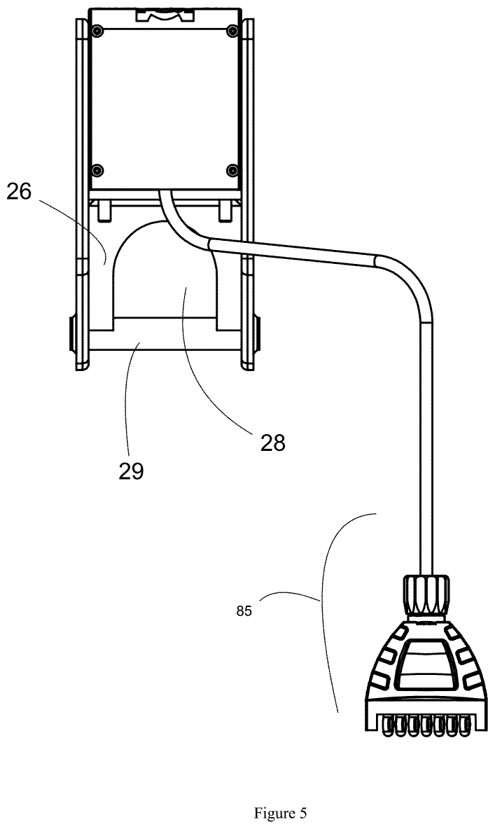

FIG. 6 is a plan view;

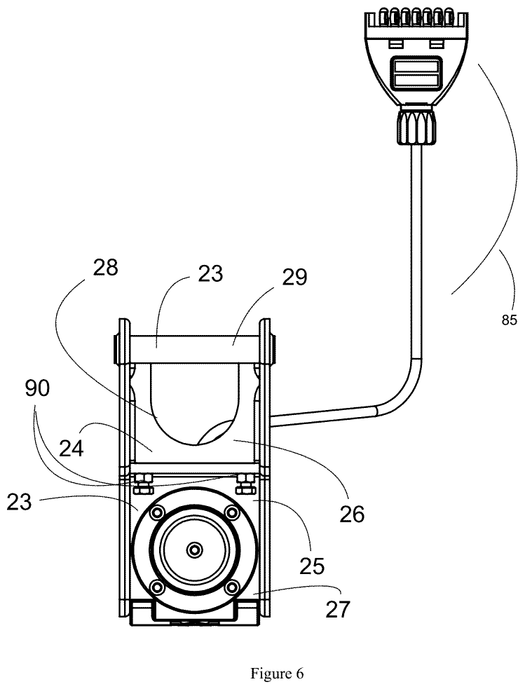

FIG. 7 is a longitudinal section view of an embodiment of the scale;

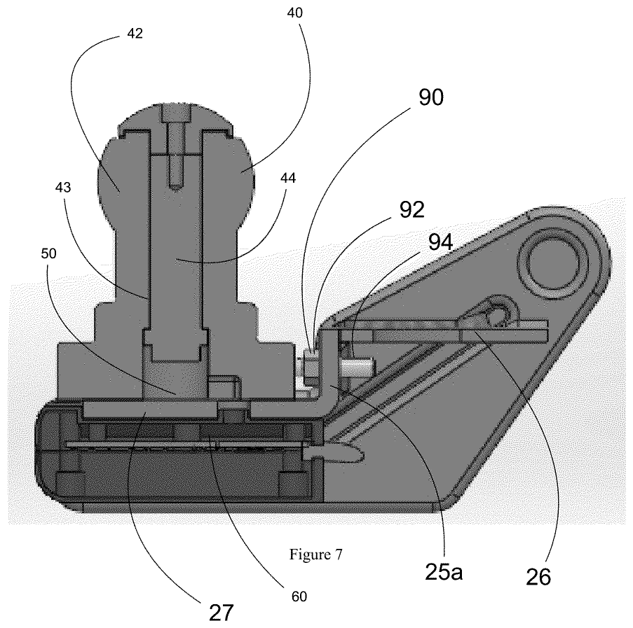

FIG. 8 is a perspective view of a prototype embodiment of the scale shown in situ on a towball of the prime mover;

FIG. 9 is a circuit board layout overlaid with a schematic drawing showing the technical systems architecture of a processing system associated with the towball scale, which is configured to execute a measuring method to measure the vertical force imparted by the towing coupling of the trailer or caravan;

FIG. 10 is a flow diagram showing the method steps executed by the technology, mainly or fully by the processing system:

FIG. 11 is a flow diagram showing method steps in an embodiment of the technology and

FIG. 12 is Table 1 which shows the calibration of load cell at discrete load intervals;

FIG. 13 is Table 2 which shows Dx and Dy for the quantities in Table 1:

FIG. 14 is Table 3 which shows Dx*Dy, SigmaDxDy, and Dx² and SigmaDx²; and

FIG. 15 shows a visual representation of the fit function.

### DESCRIPTION OF EMBODIMENTS

Referring to the drawings there is shown a scale generally indicated at 10. Advantageously, the scale 10 is more accurate than known tow ball scales, by providing a scale 10 configured to be disposed adjacent to, and at the same level as, a tow ball hitch. The scale 10 is configured to, as best as possible, without being integral with the tow ball hitch itself, replicate the towing position on each vehicle on which it is installed, for each towed vehicle. It is configured to receive the towing coupling itself and weigh the towball mass in as close a position to the towball as practically possible without the coupler being coupled to the towball itself.

The scale 10 includes a frame 20 on which a mount 30 is mounted for mounting a coupler of a caravan (not shown) or trailer (not shown) at a very similar height and location as a tow ball 99, to provide the caravan or trailer with weighing geometry similar to real-world towing conditions, which would be being mounted on the towball of a towing vehicle.

The frame 20 includes side frame elements 21 being side frame panels 22 being connected by one or more transverse frame members 23. The one or more transverse frame members 23 fasten and locate the side frame panels 22 together for strength, and include cross member 29 and base plate 24 which is folded or otherwise fabricated to form a stepped base plate 25. Stepped base plate 25 includes an upper plate 26 and a lower plate 27.

Side frame panels 22 include strengthening portion 22a. The strengthening portion 22a is a rib 22b. The rib 22b extends diagonally along from the upper plate 26 to the lower plate 27 for increased strength.

Upper plate 26 includes a locator 28 for locating a trailer hitch and towball 70 to locate the scale 10 on the towing vehicle. The locator 28 includes an aperture 28a for receiving the towball 70 and a skirt or a riser 25a for abutment against the front edge of the trailer hitch of the towing vehicle to locate the scale 10 on the hitch.

The scale includes a lock 90 for locking the frame 20 on the towing hitch of the towing vehicle. The lock 90 includes two adjustable elements 92 for driving or clamping the frame against the hitch base of the towing vehicle. The adjustable elements 92 are screws 94 which extend to drive the frame against the base of the towing hitch and thereby lock it in position.

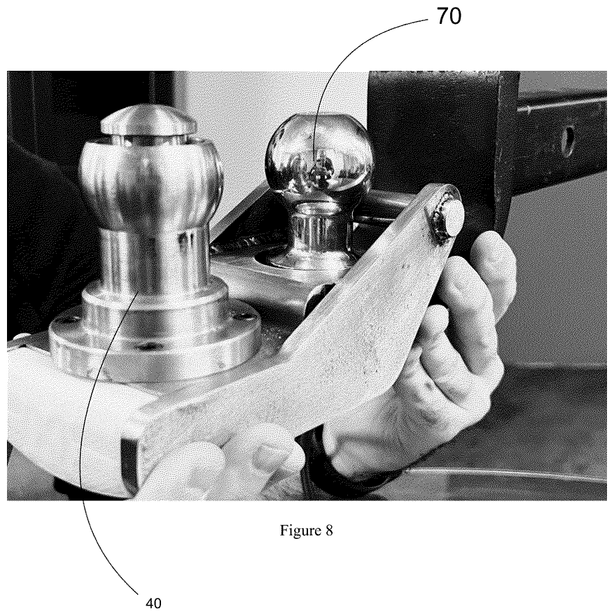

In this matter, as can be seen in FIG. 8, the frame 20 is located over the towing ball and on the hitch of the towing vehicle, very close.

On the frame 20, in particular the lower plate 27, is a mock towball or coupler receiver 40 spaced along the frame from the locator 28. The mock towball or coupler receiver 40 further includes one or more load cells 50 disposed thereon to measure the vertical load. The mock towball 40 includes a hollow towball 42 with a bore 43 for receiving a load cell actuator pin 44.

It can be seen in the figures that the load cell actuator pin 44 is fastened in the bore 43 with a fastener and/or adhesive resin.

As can be seen from the Figures, the hitch receiving zone (where the locator 28 is disposed) is disposed at a proximal end 5 of the frame, and the weighing station (where the load cell is disposed on the base plate 27) is spaced from the hitch receiving zone, toward the distal end of the frame 7.

There is also provided a processor 60 on or near the lower plate 27 which is configured to execute a method of measuring a trailer towball downforce. The processor 60 is powered by the towing vehicle, by one or more of the pins on the 7-pin socket. A wiring harness and plug shown at 85 connects the trailed vehicle power to the processor 60. Specifically, the weighing station processor is powered by the lights pin (not shown) or the auxiliary pin on the 7-pin plug.

Wireless networking to transmit and receive load data, calculation data and signals, threshold data and calculation data and command data, can be effected by the processor 60 which is an SOC and includes a wireless networking module.

### In Operation

The scale 10 is hooked over the towball 70 of the towing vehicle, and locked in place with lock 90. The wiring harness and plug 85 is connected to the towing vehicle. The processor 60 then powers on and goes through its startup routine.

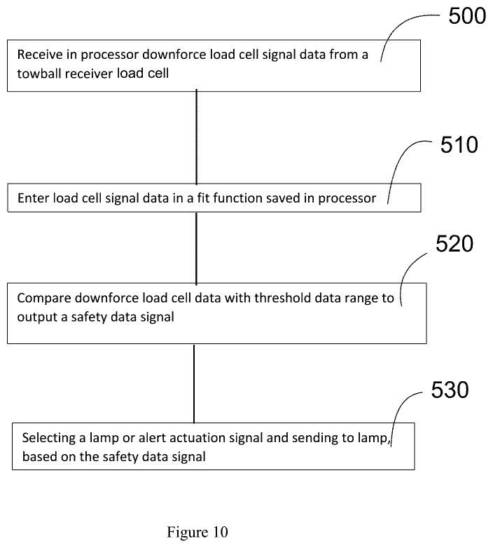

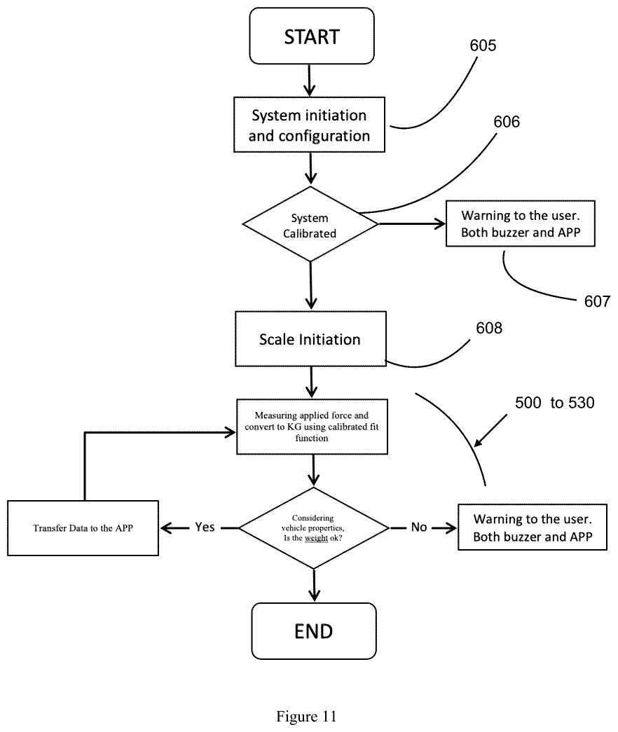

The startup routine is described below, in conjunction with FIG. 11, after the main parts of the measuring routine are described, with respect to FIG. 10.

So, a towed vehicle coupling (not shown) is brought onto the mock towball 40 and its jockey wheel is moved to a stowed position so the trailed vehicle is only supported by its axle(s) and the mock towball 40 of the scale 10.

The processor then implements a method of weighing the towball downforce of the trailer and that method includes the steps of:
1. receiving downforce load cell signal data relating to towball load in the computer processor 60 from a towball or coupler receiver (step 500 of FIG. 10);
2. using the downforce load cell signal data in a fit function saved in the computer processor 60 to output a trailer downforce load data (step 510 of FIG. 10);
3. comparing the trailer downforce load data with a threshold load data range to produce a safety data signal (step 520 of FIG. 10) (either go or no-go).

The method in this embodiment further includes the step of sending the trailer downforce load data and/or safety data signal to an onboard buzzer or lamp, and/or a mobile device (Step 530 of FIG. 10).

There is also in this embodiment of the method shown, the step of transmitting an alarm data signal to a mobile device (not shown) or loudspeaker 80, either using the tracks on the PCB or by using the wireless networking module on SOC 60 if the safety data signal shows that the trailer downforce load data is higher or lower than the threshold data range.

The startup routine is shown schematically in FIG. 11 wherein at step 605 there is shown at which stage of the measurement routine is the initiation and configuration.

After that, there is shown a calibration step at 606.

During calibration, there is an assessment made and a decision by the processor 60 as to whether the system can be successfully calibrated. If no, then the processor 60 moves to step 607 which is to warn the user with an alert or warning via the buzzer 80 or wireless networking module 60 to the mobile device (not shown). At this point the user can rearrange items in the caravan, find more level ground, or troubleshoot in other ways.

If the calibration is successful, then the processor 60 moves the process along to an initiation step 608.

The processor 60 is caused then to measure and assess the mass load on the towball in accordance with the steps in FIGS. 10 (500 to 530 as described above).

### Fit Function

The processor 60 deploys a fit function which is shown overleaf and described. The fit function is to provide an interpolated vertical towball mass depending on load cell output data from load cell 50 into processor 60.

First, a calibration data table using a discrete set of measurements between 0 and 500 kg load during calibration is stored on the processor 60, or even in the mobile device (not shown) where calculations may be made, fully or partially. The mobile device may share the calculation load with the processor 60, or merely transfer, receive and present data, depending on processor and wireless networking module design preferences.

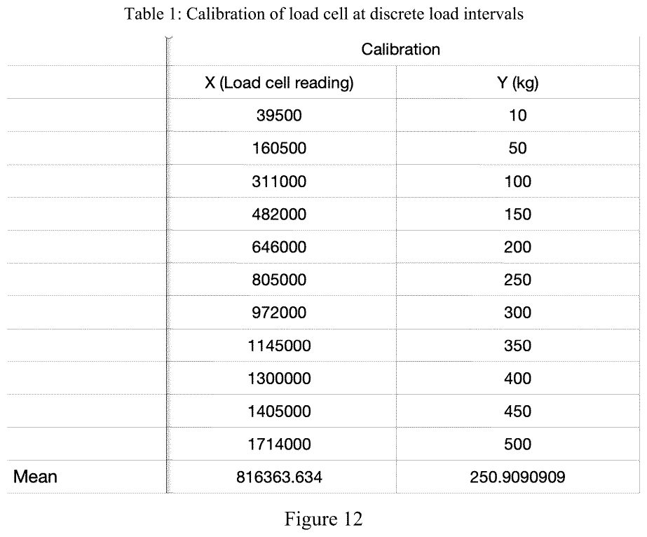

A mean load cell rating is calculated and stored as mean x and mean y. See FIG. 12, Table 1 overleaf.

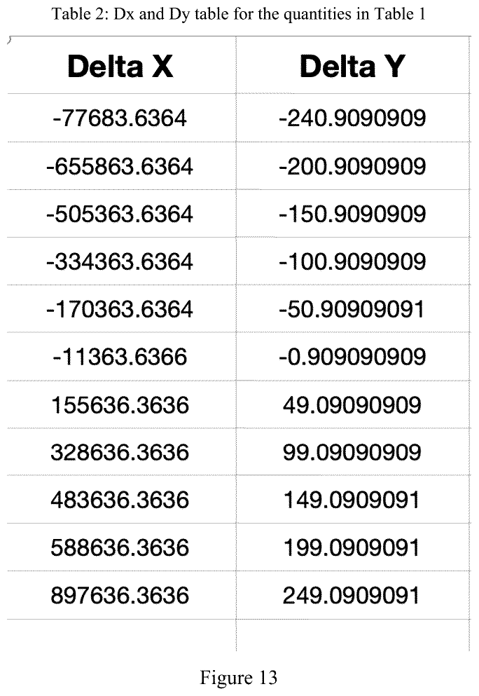

Then, the processor 60 or mobile device (not shown) calculates and records a plurality of quantities of differences between the discrete load cell readings as Delta X (Dx) and Delta Y (Dy) as shown in FIG. 13, Table 2. Delta X and Delta Y are the difference between load cell and mass readings respectively, from their respective median readings.

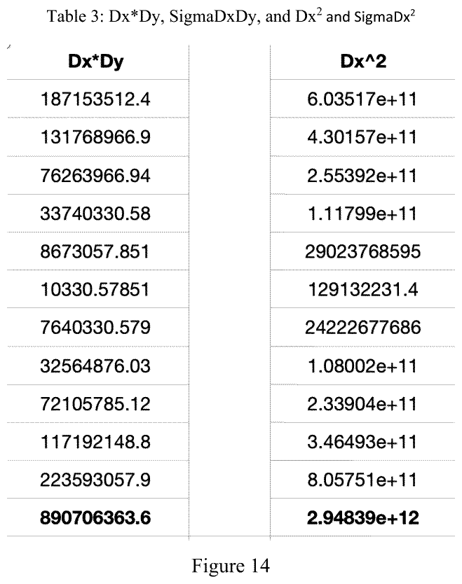

After that, the processor 60 or mobile device calculates and records quantities Dx*Dy and Dx² as shown in FIG. 14, Table 3. A sum reading is also calculated and recorded, which is the bottom number shown in the table below. The sum reading is assigned Sigma DxDy and Sigma Dx² and is the sum of the columns as shown below.

It is to be understood that these quantities do not necessarily have to be calculated in real time, but they can be loaded into the processor 60 or mobile device from an external source or from the load cell itself or from a file from the load cell manufacturer or from a load cell calibration testing station.

A gain coefficient is calculated in the processor 60 or mobile device which is assigned B1. It is defined as the sum of SigmaDxDy and SigmaDx².

An offset quantity is calculated in the processor 60 which is assigned B0. It is calculated by

$$B 0 = Mean mass - ( B 1 * mean load cell )$$

To calculate the vertical load on the towball, the load cell reading data (x) is input from the load cell 50 to the processor 60 or mobile device.

Then the processor 60 or mobile device calculates the following:

$$y = B 1 x + B 0$$

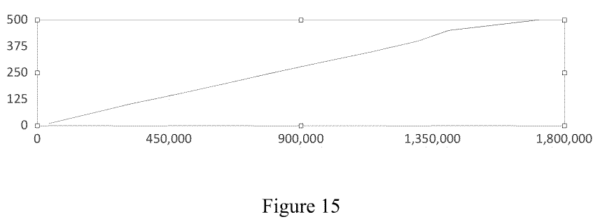

The graph shown in FIG. 15 shows a visual representation of the fit function.

The baseline signal load data point is used in the fit function stored in the processor which uses linear regression to produce a trailer down force load data point.

At this point the processor 60 or mobile device compares the trailer down force load data point with the threshold data range to produce a safe signal output or a warning signal output, depending on whether the baseline signal load data point is within a predetermined threshold or without the predetermined threshold.

The threshold data range in some embodiments is input by the user.

The threshold data range in some embodiments is calculated by the processor 60 or mobile device after presenting the user with a range of questions relating to the mass of the towed vehicle, its geometry, axle number, and like quantities. These questions can be prompted by a mobile app which transmits the results to the processor 60.

For example, if a caravan is 3000 kg in mass, then the app will instruct the processor 60 to set a threshold range of 6% to 15% of 3000 kg say. And will in use, sound alarms or send alarm signals to the mobile device if the load cell fit function returns a value outside the range of 180 kg to 450 kg.

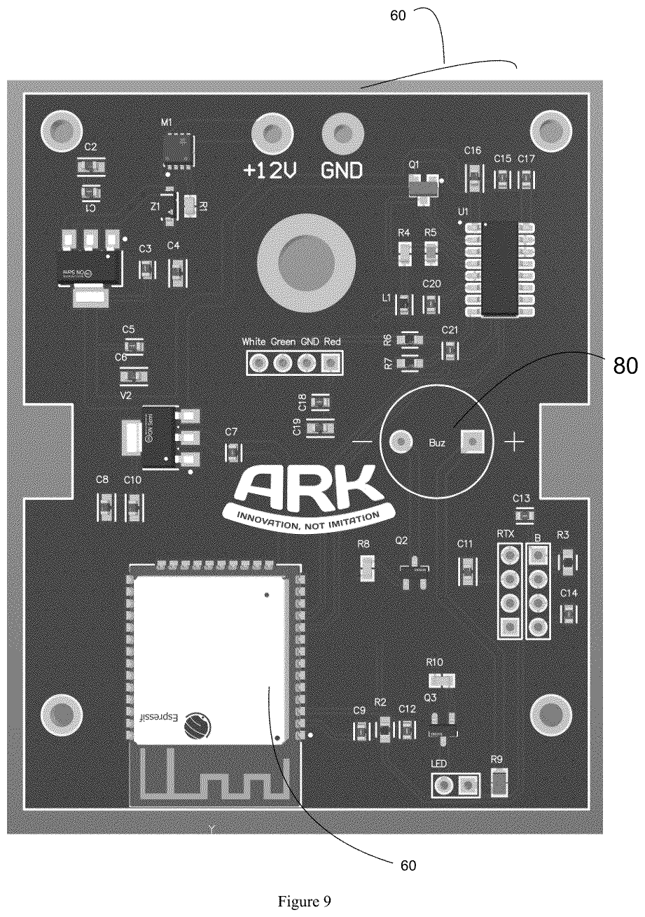

It is to be understood that portions of the processing could be done onboard the processor 60, or on the mobile device (not shown), or in a combination of both. This kind of thin or thick client behaviour, or merely data transfer of various elements or packets, can be achieved by using a wireless networking module shown in FIG. 9, generally at 60 which may be an SOC which may include a wireless networking module.

The safe signal output is a selected “safe zone” lamp activation signal sent to an onboard lamp, or to a mobile device (not shown). The lamp will be of one colour, which will be different from a lamp colour for the warning lamp.

If the comparison step yields a result outside the predetermined threshold then the processor will output a warning lamp activation signal to an onboard warning lamp, or buzzer 80.

It will be understood to persons skilled in the art of the invention that many modifications may be made without departing from the spirit and scope of the invention.

It is to be understood that any prior art publication referred to herein does not constitute an admission that the publication forms part of the common general knowledge in the art.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A tow ball load scale including:
a frame including:
a mount at a proximal end for mounting the frame to a coupler, towball or hitch of a prime mover;
a weighing station disposed on a second coupling region, adjacent the mount on the frame.

2. The scale in accordance with claim 1 wherein the weighing station includes a towball, or coupler receiver, spaced along the frame from the mount towards a distal end, the towball or coupler mount being configured to cooperate with a trailer coupler for measuring a vertical towball load, and further including one or more load cells disposed thereon.

3. The scale in accordance with claim 2 wherein the mount includes a hitch receiving zone to receive a hitch.

4. The scale in accordance with claim 3 wherein the hitch receiving zone includes a towball retainer.

5. The scale in accordance with claim 4 wherein the hitch receiving zone includes a skirt for locating the frame on a hitch tongue.

6. The scale in accordance with claim 5 wherein the towball retainer includes a towball retaining bar at a proximal end of the frame, to hook under the shoulder of a towball, inhibiting release under load.

7. The scale in accordance with claim 6 wherein the hitch receiving zone is at a proximal end of the frame, and the weighing station is spaced from the hitch receiving zone, toward the distal end of the frame.

8. The scale in accordance with claim 7 wherein an adjuster is provided which adjusts the level of the weighing station relative to the mount.

9. The scale in accordance with claim 8 wherein there is provided a lock to lock the frame onto the hitch tongue of the prime mover.

10. The scale in accordance with claim 9 wherein the lock is a threaded screw or bolt mounted on the riser or skirt, which can lock the frame to the hitch of the towing vehicle.

11. The scale in accordance with claim 3 wherein the weighing station is a mock towball.

12. The scale in accordance with claim 11 wherein the mock towball includes a single 1-axis load cell, oriented to measure vertical load.

13. The scale in accordance with claim 12 wherein the mock towball includes a hollow towball with a bore for receiving a load cell actuator pin.

14. The scale in accordance with claim 13 wherein the load cell actuator pin is fastened in the bore with a fastener and/or adhesive resin.

15. The scale in accordance with claim 14 wherein the weighing station includes alert lights of different colours for different load conditions calculated by the processor.

16. The scale in accordance with claim 15 wherein the weighing station includes loudspeaker for making alert sounds.

17. The scale in accordance with claim 16 wherein the weighing station is powered by a trailer plug.

18. The scale in accordance with claim 17 wherein the weighing station includes a trailer plug with at least one power pin to the auxiliary pin on the prime mover socket and/or the lights pin on the prime mover socket.
